(19) United States
(12) Patent Application Publication
(10) Pub. No.: US 2026/0325399 A1
(43) Pub. Date: Oct. 22, 2026

(54) SILICONE TOY AND INFLATABLE STRUCTURE

(71) Applicant: VENES LIMITED, HONG KONG (CN)

(72) Inventor: Hanfen Liu, Dongguan (CN)

(21) Appl. No.: 19/180,662

(22) Filed: Apr. 16, 2025

(51) Int. Cl. A61H 19/00; F04B 33/00

(52) U.S. Cl. CPC A61H 19/44; F04B 33/00; A61H 2201/0103; A61H 2201/169

(57) ABSTRACT

A silicone toy and an inflatable structure, comprising a silicone toy and an inflatable structure, wherein the silicone toy is provided with a solid silicone support body embedded therein, and an inner bottom of the silicone support body is installed with a metal three-way connector; the inflatable structure comprises an air-tight metal ring and a needle valve-guided silicone head; the needle valve-guided silicone head is arranged at a bottom of the silicone support body and connected to the metal three-way connector, and the air-tight metal ring and the needle valve-guided silicone head form an interference fit to achieve airtight sealing; the silicone support body is provided with an air channel connected to the metal three-way connector. The invention belongs to the technical field of adult products, and specifically refers to a silicone toy and an inflatable structure.

### TECHNICAL FIELD

The invention belongs to the technical field of adult products, and specifically refers to a silicone toy and an inflatable structure.

The present invention relates to the technical field of adult novelty devices, and more specifically to a silicone adult toy equipped with an inflatable structural component.

### BACKGROUND ART

The common inflatable adult toys on the market generally adopt a single-layer hollow construction and require inflation before use. These products typically feel like a balloon-soft, unstable, and filled with a large internal cavity.

Without inflation, they cannot provide a realistic tactile experience, making them unusable in their deflated state.

In contrast, the present invention introduces a dual-layer silicone structure that retains a natural and comfortable feel even without inflation. The toy can be used directly in a deflated state while still providing realistic handfeel effectively addressing the shortcomings of current products.

Furthermore, after inflation, the new design delivers a much more realistic, dual-layer tactile experience, as opposed to the air-filled, balloon-like sensation typical of single-layer products.

In existing products, the inflation process typically relies on an inflatable bulb that is permanently connected to the toy, which cannot be detached and often hinders user convenience and flexibility during use.

The present invention, through its innovative structural design, allows the inflation device to be detached from the toy body after inflation is completed.

This effectively solves one of the most frustrating problems faced by consumers, greatly enhancing convenience and comfort during use.

### SUMMARY OF THE INVENTION

In view of the above situation, in order to overcome the defects of the prior art, the invention provides a silicone toy and an inflatable structure, which effectively solves the problem that the silicone toys in the prior art can only be used after being inflated.

In order to achieve the above function, the invention adopts the following technical solution: a silicone toy and an inflatable structure, comprising a silicone toy and an inflatable structure, wherein the silicone toy is provided with a solid silicone support body embedded therein, and an inner bottom of the silicone support body is installed with a metal three-way connector; the inflatable structure comprises an air-tight metal ring and a needle valve-guided silicone head; the needle valve-guided silicone head is arranged at the bottom of the silicone support body and connected to the metal three-way connector, and the air-tight metal ring and the needle valve-guided silicone head form an interference fit to achieve airtight sealing; the silicone support body is provided with an air channel connected to the metal three-way connector for inflation.

Preferably, the air channel extends through a top of the silicone support body and tightly adheres to an inner wall of the silicone toy.

Preferably, an inflation needle is inserted into the needle valve-guided silicone head, one end of which is connected to an air pump needle valve installed on a universal manual air pump.

Preferably, the metal three-way connector has standard threads machined on its metal surface.

Preferably, the metal three-way connector and the air-tight metal ring are both made of stainless steel.

Preferably, the silicone support body has an external contour conforming to the shape of the silicone toy, and the silicone support body is positioned along the central axis of the silicone toy.

After adopting the above structure, the invention has the following beneficial effects:
1. the silicone toy according to the invention can be used in an uninflated state, which overcomes the defect that the traditional hollow balloon structure toy cannot support the appearance shape before use, and provides users with a more convenient use experience.
2. The invention adopts a metal ring to lock the needle valve-guided silicone head for air sealing, which has a simple structure, low cost and efficient and reliable air sealing effect, thereby reducing the production cost and use risk of the product.
3. The invention provides rigid support through the metal three-way connector and the expansibility of external screw thread accessories, which not only enhances the structural strength of the toy, but also greatly enriches the functions of the toy, meets the diverse needs of different users, and enhances the market competitiveness of the product.

### BRIEF DESCRIPTION OF THE DRAWINGS

FIG. 1 is an overall structure diagram of the silicone toy and an inflatable structure according to the invention;

FIG. 2 is a first schematic diagram of the overall structure of the silicone toy and an inflatable structure according to the invention;

FIG. 3 is a second schematic diagram of the overall structure of the silicone toy and an inflatable structure according to the invention;

FIG. 4 is a first cross-sectional view of the silicone toy and an inflatable structure according to the invention;

FIG. 5 is a partial enlarged view of part A in FIG. 3;

FIG. 6 is a second cross-sectional view of the silicone toy and an inflatable structure according to the invention.

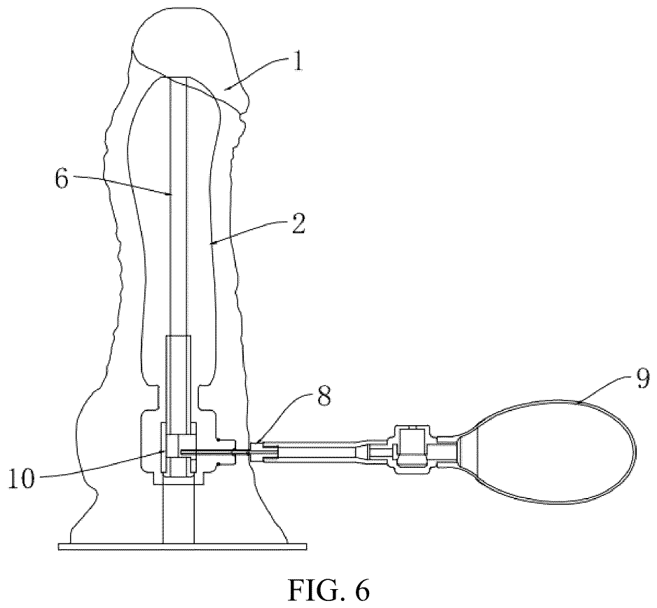

In the figures: 1 refers to the silicone toy; 2 refers to the silicone support body; 3 refers to the inflatable structure; 4 refers to the air-tight metal ring; 5 refers to the needle valve-guided silicone head; 6 refers to the air channel; 7 refers to the inflation needle; 8 refers to the air pump needle valve; 9 refers to the air pump; 10 refers to the metal three-way connector.

### SPECIFIC EMBODIMENT OF THE INVENTION

The invention will be further described in detail hereinafter with reference to the drawings.

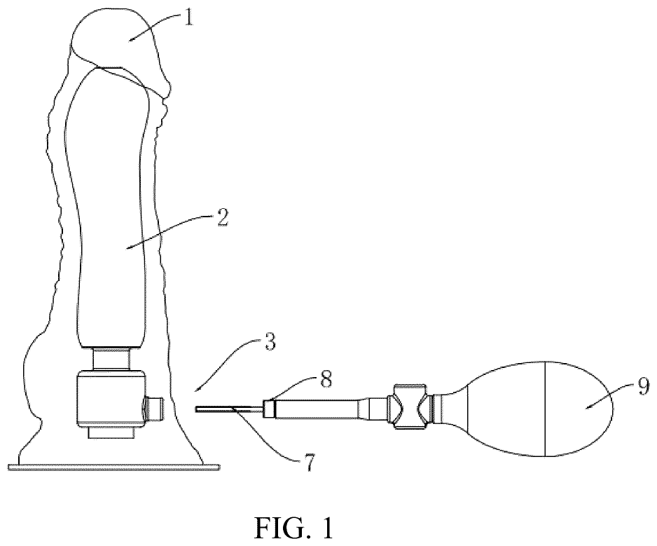

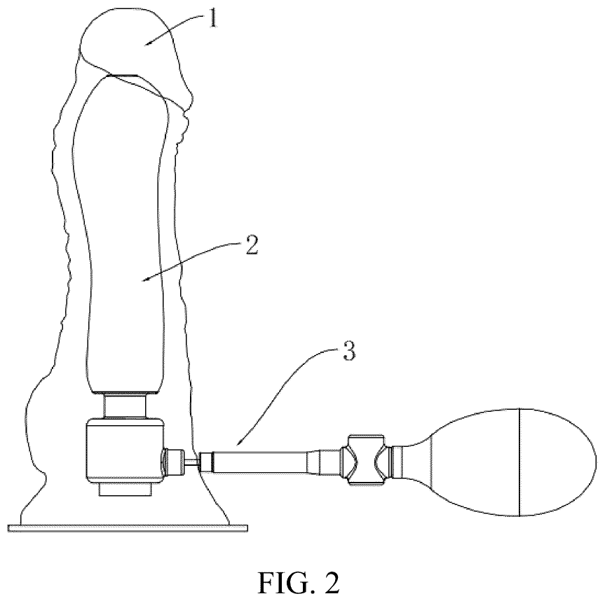

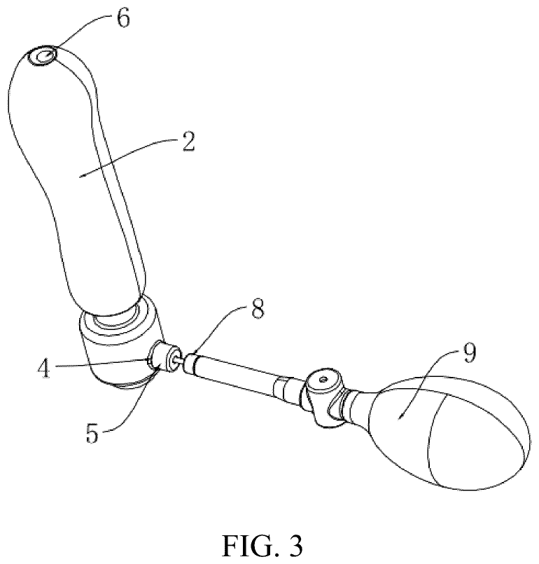

As shown in FIGS. 1-5, a silicone toy and an inflatable structure proposed by the invention, comprising a silicone toy 1 and an inflatable structure 3; the overall shape of the silicone toy 1 simulates the male genitals, and its exterior is made of soft silicone, which is elastic and fleshy, and is ergonomically designed to bring a comfortable experience to the user; the silicone toy 1 is provided with a solid silicone support body 2 embedded therein; the silicone support body 2 has an external contour conforming to the shape of the silicone toy 1, and the silicone support body 2 is positioned along the central axis of the silicone toy 1 to ensure uniform force in all directions; when the user holds or uses the toy, the support body can make the external silicone uniformly stressed and not deformed;
an inner bottom of the silicone support body 2 is installed with a metal three-way connector 10; the inflatable structure comprises an air-tight metal ring 4 and a needle valve-guided silicone head 5; the needle valve-guided silicone head 5 is arranged at a bottom of the silicone support body 2 and connected to the metal three-way connector 10, and the air-tight metal ring 4 and the needle valve-guided silicone head 5 form an interference fit to achieve airtight sealing; the metal three-way connector 10 and the air-tight metal ring 4 are both made of stainless steel; the stainless steel metal ring is not easy to react chemically with silicone and will not have adverse effects on the performance and quality of silicone; the silicone support body 2 is provided with an air channel 6 connected to the metal three-way connector 10 for inflation; the air channel 6 extends through a top of the silicone support body 2 and tightly adheres to an inner wall of the silicone toy 1 to achieve seamless connection.

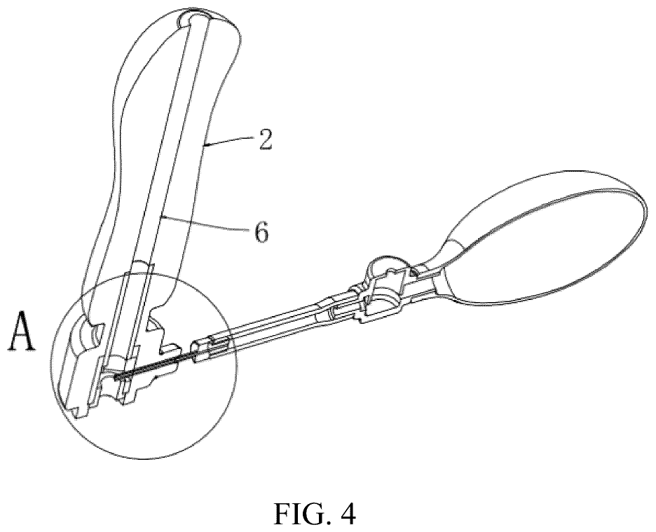

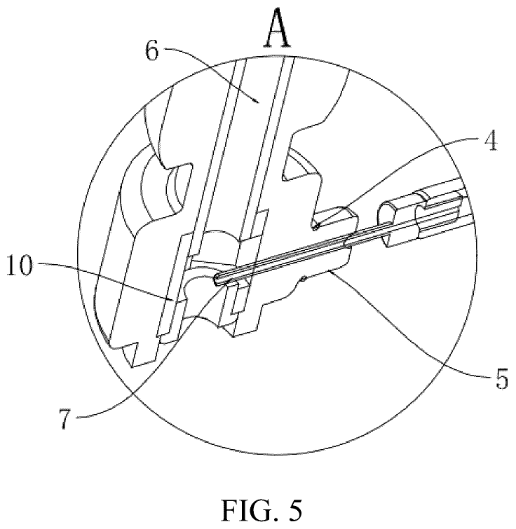

As shown in FIGS. 4 and 5, an inflation needle 7 is inserted into the needle valve-guided silicone head 5, one end of which is connected to an air pump needle valve 8 installed on a universal manual air pump 9; this air pump 9 is small in size, easy to carry and operate; it generates airflow by manual pressing to inject air into the silicone toy 1, and does not require power and can be used anytime and anywhere, which is suitable for individuals to inflate the silicone toy 1 in different scenarios.

The metal three-way connector 10 has standard threads machined on its metal surface. Users can choose various external accessories with matching screw threads according to their actual needs and creativity. Whether it is a massage component with special functions, decorative parts of different shapes, or auxiliary tools that can change the way the toy is used, they can be easily connected to the toy through the screw threads. The expandable design of this external screw thread accessory greatly enriches the function and use of the toy and meets the diverse and personalized needs of different users.

When in use, the user can directly use the toy in the uninflated state. At this time, the solid silicone support body 2 provides stable support to maintain the appearance of the toy and meet the user's usage needs;
when the user needs to change certain characteristics of the toy or add functions, he can choose a suitable screw thread accessory according to his own needs and screw it on the screw thread of the metal three-way connector 10 to achieve functional expansion;
if the user wants to use the inflation function, he can use a universal manual air pump 9: align the inflation needle 7 with the needle valve-guided silicone head 5 and insert it, so that one end of the inflation needle 7 is placed in the metal three-way connector 10, and manually press to generate airflow, and inject air into the silicone toy 1 through the air channel 6; after inflation, the inflation needle 7 is pulled out of the needle valve-guided silicone head 5, and the air is automatically closed under the locking action of the metal ring.

1. A silicone toy and an inflatable structure, comprising a silicone toy and an inflatable structure, wherein the silicone toy is provided with a solid silicone support body embedded therein, and an inner bottom of the silicone support body is installed with a metal three-way connector;
the inflatable structure comprises an air-tight metal ring and a needle valve-guided silicone head; the needle valve-guided silicone head is arranged at a bottom of the silicone support body and connected to the metal three-way connector, and the air-tight metal ring and the needle valve-guided silicone head form an interference fit to achieve airtight sealing; the silicone support body is provided with an air channel connected to the metal three-way connector for inflation.

2. The silicone toy and an inflatable structure of claim 1, wherein the air channel extends through a top of the silicone support body and tightly adheres to an inner wall of the silicone toy.

3. The silicone toy and an inflatable structure of claim 2, wherein an inflation needle is inserted into the needle valve-guided silicone head, one end of which is connected to an air pump needle valve installed on a universal manual air pump.

4. The silicone toy and an inflatable structure of claim 1, wherein the metal three-way connector has standard threads machined on its metal surface.

5. The silicone toy and an inflatable structure of claim 4, wherein the metal three-way connector and the air-tight metal ring are both made of stainless steel.

6. The silicone toy and an inflatable structure of claim 1, wherein the silicone support body has an external contour conforming to the shape of the silicone toy, and the silicone support body is positioned along the central axis of the silicone toy.
